(19) United States
(12) Patent Application Publication
(10) Pub. No.: US 2018/0270582 A1
(43) Pub. Date: Sep. 20, 2018

(54) DYNAMIC SPEAKER WITH A MAGNET SYSTEM

(71) Applicant: Sound Solutions International Co., Ltd., Beijing (CN)

(72) Inventors: Ben-Daniel Keller, Vienna (AT); Gustav Otto, Vienna (AT); Friedrich Reining, Vienna (AT)

(21) Appl. No.: 15/919,820

(22) Filed: Mar. 13, 2018

(30) Foreign Application Priority Data
Mar. 15, 2017 (AT) A 50208/2017

(51) Int. Cl. H04R 9/06; H04R 9/02; H04R 9/04; H04R 7/18; H04R 7/04

(52) U.S. Cl. CPC H04R 9/06; H04R 9/025; H04R 2499/11; H04R 7/18; H04R 7/04; H04R 9/046

(57) ABSTRACT

A dynamic loudspeaker driver, comprising: a magnet-system; a membrane; the membrane being movably mounted with respect to the magnet-system; at least one voice coil attached to the membrane and operatively coupled with the magnet-system; at least one figure 8-shaped coil attached to the membrane and to a lateral surface of the at least one voice coil.

### CROSS-REFERENCE TO RELATED APPLICATIONS

This application claims priority to Austria Patent Application No. A50208/2017, filed on Mar. 15, 2017, which is hereby incorporated by reference in its entirety.

### BACKGROUND

### a. Technical Field

The invention relates to a dynamic loudspeaker driver, to a loudspeaker comprising the dynamic loudspeaker driver and to a mobile device, such as a mobile phone, comprising the loudspeaker.

The invention also relates to a method of producing a loudspeaker driver.

### b. Background

A dynamic loudspeaker driver usually comprises a magnet system, a membrane movably mounted with respect to the magnet system, and a voice coil attached to the membrane. The magnet system comprises a magnet and the voice coil is operatively coupled with the magnet. Usually, a loudspeaker comprises an enclosure and at least one dynamic loudspeaker driver mounted in the enclosure.

When operating, an electric signal is applied to the voice coil, for instance, by an amplifier. Then, the membrane moves with respect to the magnet system and with respect to the enclosure in response to the electric signal, resulting in moving air. A sound-pressure level of the loudspeaker depends on the air moved by the membrane.

When moving, the membrane is subjected to air pressure of the ambient air and the air within the enclosure, forming a load for the moving membrane. Since the membrane is not absolutely stiff, this pressure results in deforming the membrane, potentially reducing the sound quality of the loudspeaker.

When maximizing the performance of a speaker to output high sound pressure an important parameter is a piston wise movement of the membrane. Asymmetry of the mechanical system of a speaker results in asymmetric movements or tumbling of the membrane. This can reduce the sound pressure output power and may result in severe rubbing and buzzing and even damaging of the mechanical system of the speaker. Prior attempts to solve this problem of a tumbling membrane are based on damping membrane materials. The efficiency of such damping, however, can strongly depend on environmental conditions. The invention described herein provides for damping of a tumbling membrane by electrical means and is therefore in a wide range independent from environmental conditions.

Since common membrane designs cannot prevent the system from tumbling, usage of damping membrane material is the most effective and cheap solution. Membrane material, however, has to fulfil many requirements, including having the following characteristics: 1) stabile, frequency-independent stiffness and damping; 2) robustness against mechanical long term stresses; and 3) low cost and good process ability.

Actual materials are always a compromise when it comes to fulfilment of all these requirements, resulting in more or less distortion in the output sound pressure. The resulting total harmonic distortion (THD) is one method used to rate the performance of membranes.

Overcoming tumbling through electrical means requires a method to detect and/or measure the damping during operation of the speaker. One method of doing so is to include a sensor coil wound over the whole height of the voice coil that drives the membrane. The magnetic flux of the magnet system of the speaker will induce a voltage in both coils depending of the actual position of the coil with respect to the magnet system. In a single coil sensor, the induced voltage caused by the forces of tumbling will cancel out due to the fact that the rotational center tends to be through the center of gravity for the coil. The tumbling of the membrane thus cannot be detected.

For solving the above problem US 20170026746A1 teaches to use a figure 8-shaped coil on top of the membrane and the voice coil. But, it has turned out that attaching the figure 8-shaped coil to a front end of the voice coil as disclosed in US 20170026746A1 is not optimal for realizing a passive damping of the membrane.

### BRIEF SUMMARY

It is an object of the present invention to solve the tumbling problem without the usage of additional mechanical requirements for the membrane material and to provide a dynamic loudspeaker driver with improved sound quality.

Another object of the invention is to provide an improved loudspeaker and a further object of the invention is to provide an improved mobile device, for instance, a mobile phone.

The above objects are achieved by means of a dynamic loudspeaker driver, in particular a loudspeaker driver for a loudspeaker of mobile devices such as mobile phones, tablets, gaming devices, notebooks or similar devices, comprising a magnet-system a membrane; the membrane being movably mounted with respect to the magnet-system; at least one voice coil attached to the membrane and operatively coupled with the magnet-system; at least one figure 8-shaped coil attached to the membrane and to a lateral surface of the at least one voice coil. If the figure 8-shaped coil moves within the magnetic field of the magnet-system a respective voltage is induced in this coil causing current to flow and hence an electromagnetic force reducing tumbling of the membrane. Due to the attachment of the figure 8-shaped coil to lateral surface of the voice coil the figure 8-shaped coil is always facing the same magnetic field as the voice coil and tumbling can be prevented very efficiently.

According to an embodiment the at least one figure 8-shaped coil is arranged between the membrane and the voice coil.

Preferably lateral portions of the at least one figure 8-shaped coil are attached to at least two areas of the lateral surface of the voice coil opposing each other diametrically.

In a preferred embodiment the at least one figure 8-shaped coil comprises a base portion attached to the membrane and the lateral portions attached to the voice coil, wherein the lateral portions of the figure 8-shaped coil are tilted with respect to the base portion of the figure 8-shaped coil.

In an embodiment the base portion of the at least one figure 8-shaped coil comprises at least two plate or film shaped parts, wherein a bonding layer is arranged in between a first plate or film shaped part of the two plate or film shaped parts and a second plate or film shaped part of the two plate or film shaped parts.

The bonding layer can be made of an electrically insulating material.

In an embodiment the first plate or film shaped part is electrically connected to the second plate or film shaped part by means of the lateral portions.

To increase suppression of membrane rocking the loudspeaker driver may comprise at least two figure 8-shaped coils attached to the membrane and the voice coils and at least partially covering lateral surface areas of the at least one voice coil, wherein a second figure 8-shaped coil of the at least two figure 8-shaped coils is rotated with regard to a first figure 8-shaped coil of the at least two figure 8-shaped coil about an axis perpendicular to a surface of the membrane.

Suppression of membrane rocking may be further enhanced if the second figure 8-shaped coil is rotated about 90° with regard to the first figure 8-shaped coil.

In an embodiment the first figure 8-shaped coil and the second figure 8-shaped coil are bonded together by means of a bonding layer.

Preferably the bonding layer is made of an electrically insulating material.

According to an advantageous embodiment the at least one voice coil comprises at least two coils arranged coaxially to each other, wherein the lateral portions of the at least one figure 8-shaped coil are at least partially arranged in between the at least two coils.

A method of producing a loudspeaker driver according to the invention comprises the steps of:

Providing a film of electrically conductive material;

Cutting or stamping of the film to achieve a loop shape structure;

Folding of the loop shaped structure;

Attaching at least a base part of the folded loop shaped structure to a membrane of the loudspeaker driver;

Attaching lateral areas of the folded loop-shaped structure onto the voice coil and at least partially covering lateral surfaces of a voice coil of the loudspeaker driver with the lateral areas of the folded loop-shaped structure.

In an embodiment adhesive is applied to the overlapping areas forming the base part before folding of the loop shaped structure.

According to a preferred embodiment the surface of the film is treated to become electrically insulating before step iii).

The film may be cut in step ii) into a shape having two main areas lying side by side and being spaced apart from each other by means of a gap; the first and the second main area being electrically and mechanically connected with one another by means of two strips connecting corresponding edges of the two main areas.

In an embodiment the method comprises the step of folding the film along a symmetry axis intersecting the two strips, and bringing the first main area into alignment with the second main area.

According to a further embodiment the method may comprise the steps of producing a first and a second folded loop-shaped structure; bonding together of the first and second folded loop-shaped structure, wherein a symmetry axis of the second folded loop-shaped structure traverses a symmetry axis of the first folded loop-shaped structure; attaching a base portion of the first or the second loop-shaped structure to the membrane and lateral areas of the first and the second loop-shaped structures to lateral surfaces of the voice coil.

A good suppression of membrane rocking can be achieved if the symmetry axis of the first folded loop-shaped structure is essentially perpendicular to the symmetry axis of the second folded loop-shaped structure.

According to an embodiment the film may be a metal-film, in particular the metal-film may be an aluminum film.

In an embodiment at least two coils are used to produce the at least one voice coil and wherein lateral areas of the at least one figure 8-shaped coil are arranged in between the at least two coils.

### BRIEF DESCRIPTION OF THE DRAWINGS

Further embodiments of the invention are indicated in the figures and in the dependent claims The invention will now be explained in detail by the drawings. In the drawings:

FIG. 1 shows a perspective view of some of the relevant parts of a prior art rectangular loudspeaker driver;

FIG. 2 shows two sectional drawings of part of the speaker of FIG. 1;

FIG. 3 shows a sectional view of some of the relevant parts of a rectangular loudspeaker driver according to an aspect of the invention, having a figure-8 shaped coil;

FIG. 4 shows a perspective view of some of the relevant parts of a rectangular loudspeaker driver according to an aspect of the invention, having a figure-8 shaped coil;

FIG. 5 illustrates some relevant steps of a first method according to an aspect of the invention;

FIG. 6 shows an unfolded structure of a figure 8-shaped coil according to an aspect of the invention;

FIG. 7 shows the embodiment of FIG. 6 after folding;

FIG. 8 shows a sectional view of two figure 8-shaped coils bonded together;

FIG. 9 shows a further embodiment of an unfolded structure of a figure 8-shaped coil;

FIG. 10 shows the embodiment of FIG. 9 after folding;

FIG. 11 shows a sectional view of some of the relevant parts of a rectangular loudspeaker driver according to another embodiment of the invention;

FIG. 12 shows an exploded view of the voice coil of FIG. 11 with a figure 8-shaped coil attached.

### DETAILED DESCRIPTION

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

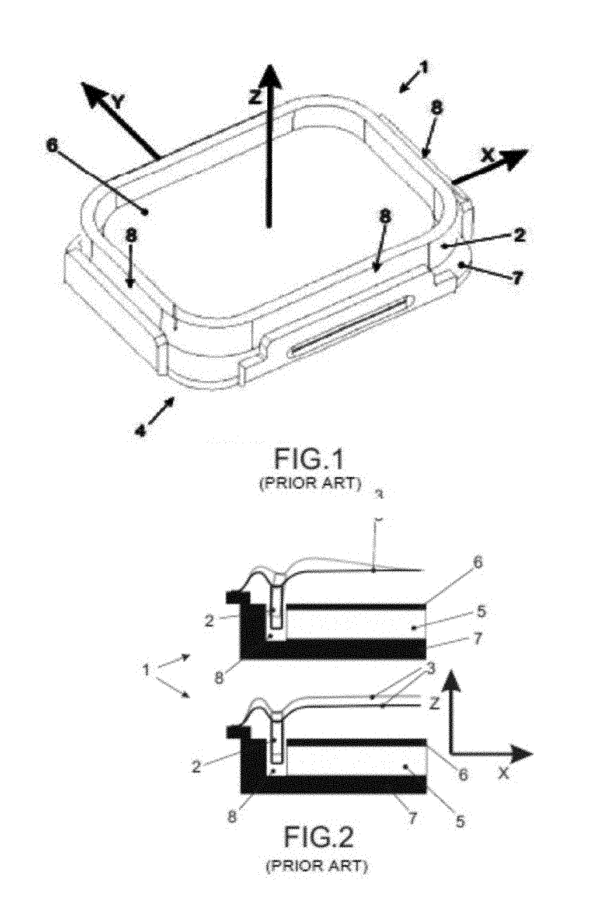

FIGS. 1 and 2 show views of some of the relevant parts of a prior art rectangular loudspeaker driver 1. FIG. 1 shows a perspective view and FIG. 2 shows two sectional views. Speaker 1 comprises a voice coil 2 with leads (unshown) to feed an electrical signal into voice coil 2. When loudspeaker driver 1 is assembled, voice coil 2 is fixed to a membrane 3 with, e.g. glue. A membrane 3 of loudspeaker driver 1 is typically made from one or more layers of material, such as Ethere Ketone (PEEK) and/or Acrylat and/or Thermoplastic Elastomeric (TEP) and/or Polyetherimide (PEI). The assembled loudspeaker driver 1 may also comprise a membrane plate (unshown) to stiffen the membrane 3.

Prior art speaker 1 furthermore comprises a magnet system 4 with a magnet 5 arranged in the center of speaker 1. The magnet system 4 furthermore comprises magnetic field guiding means comprising a top plate 6 fixed to magnet 5 and a pot 7. The magnetic field guiding means guides and focuses the magnetic field of magnet 5 in an air gap 8 between the magnet 5 and the sides of the pot 7. The voice coil 2 is arranged in the air gap 8.

The two sectional drawings in FIG. 2 show the movement of voice coil 2 and membrane 3. In the lower sectional drawing, a loudspeaker driver 1 having a perfect mechanical system is shown. The piston-wise movement of voice coil 2 causes movement of the membrane 3 in the direction of the Z-axis. The upper sectional drawing shows the asymmetry of the real mechanical system of loudspeaker driver 1, which results in asymmetrical movements, or tumbling, of membrane 3. Tumbling of the membrane 3 occurs both along the X-axis and the Y-axis. For purposes of this disclosure, the axes X, Y and Z are defined as intersecting in the middle of the width and length dimension of membrane 3. This definition also works for annular as well as rectangular transducer designs.

Although the resulting force in a dynamic speaker produces movements of membrane 3 perpendicular to the surface of membrane 3 along axis Z, small force components along axes X and Y are unavoidable. These components result in tumbling of membrane 3, where membrane 3 moves in a rotational manner, which produces no acoustic flow. The tumbling of membrane 3 can be split into two components along both axes X and Y. For a rectangular transducer, the two components of membrane tumbling can be called the length and width tumbling modes.

Optimization of the performance for a loudspeaker driver 1 typically involves maximizing the magnetic force by minimizing the air gap 8 between magnet 5 and pot 7. The tumbling movement of the voice coil 2 causes periodic touching of voice coil 2 against the magnet 5 or the pot 7, leading to a buzz or rubbing, which may lead to damage of any of the components.

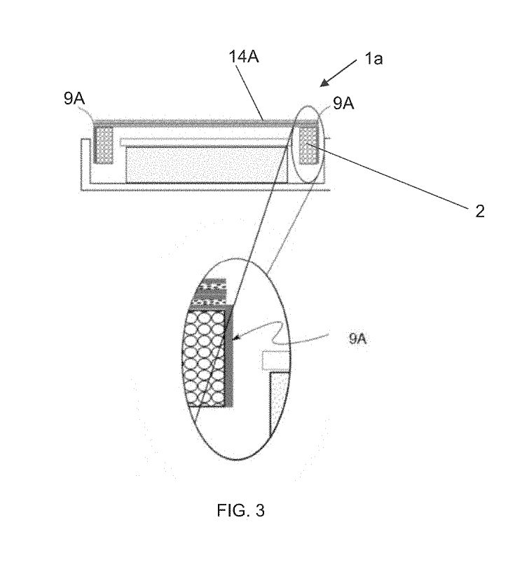

It is therefore necessary to find a way to suppress tumbling electrically with a coil 9 of loud speaker driver la according to a first embodiment of the invention shown in FIG. 3. For a speaker with a single voice coil, like the prior art speaker 1, the rotational center is found within the center of gravity of the voice coil, and induced voltage due to the tumbling movement is cancelled out. No electrical footprint of the tumbling mode can be found in the impedance curve of a single coil system. Coil 9 therefore is formed in a figure-8 shape. Any rotational movement around the axis X induces voltage in the figure-8 shaped coil 9A, but voltage induced from piston wise movement along axis Z is cancelled out.

The voltage induced in voice coil 2 reduces the voltage actually found on the terminals of voice coil 2, measurable as the typical transducer impedance peak around resonance. This principle can be applied to damp the tumble modes as well. Since it is not possible to form voice coil 2 in a way to work as a voice coil and additionally as a figure-8 shaped coil at the same time, a separate figure-8 shaped coil 9A is used to passively damp these rocking modes.

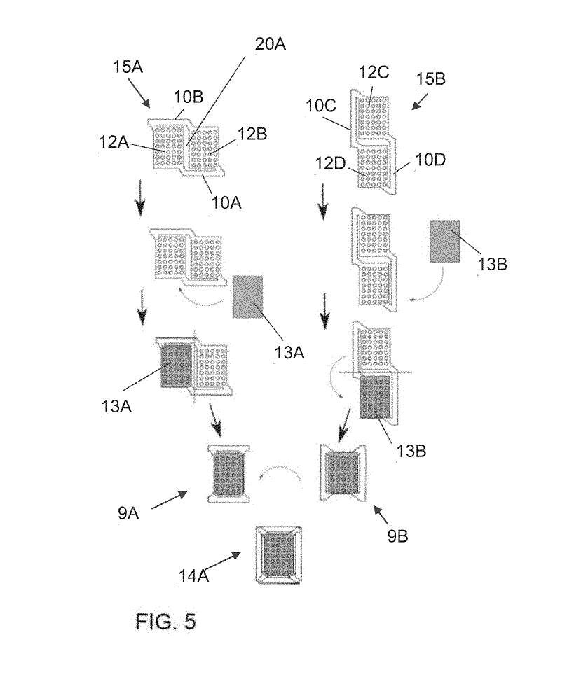

According to the invention the figure 8-shaped coil 9A is attached to the membrane 3 and to a lateral surface of the voice coil 2. Preferably the figure 8-shaped coil 9A is arranged between the membrane and the voice coil 2. It should be mentioned that the lateral surface of the at least one voice coil 2 preferably extends essentially perpendicular to the membrane 3, if the membrane 3 is not actuated. The figure 8-shaped coil 9A constitutes a membrane plate 14A which may be glued to a surface of the membrane facing the voice coil 2. Due to the membrane plate 14A according to the invention stiffness of the membrane may be increased very effectively in a space-saving manner. It should be mentioned that the membrane plate 14A can be constituted by only one single figure 8-shaped coil 9A or 9B as shown in FIG. 5 or otherwise may comprise two figure 8-shaped coils 9A, 9B. The same is true for all of the other embodiments of figure 8-shaped coils.

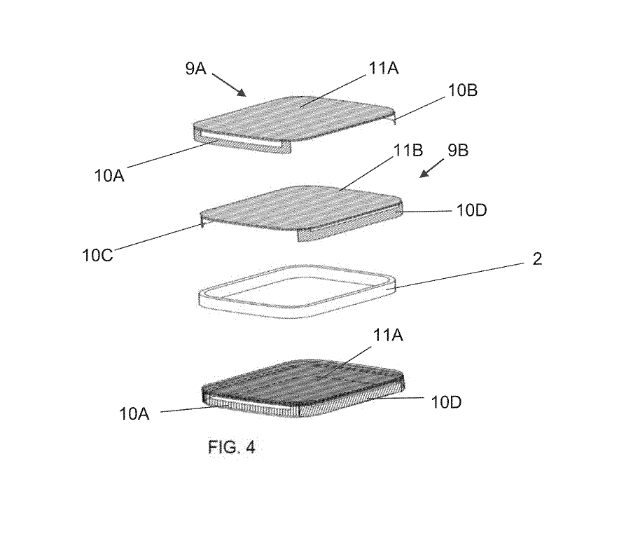

Since tumbling comprises two tumbling modes along axes X and Y, preferably two figure 8 shaped coils 9A and 9B are used to damp tumbling along axis X and to damp the tumbling along axis Y as can be seen from FIG. 4. The figure-8 shaped coils 9A and 9B function as passive damping coils.

The two figure 8-shaped coils 9A, 9B are attached to an underside of membrane 3 and to the voice coil 2. Lateral portions 10A, 10B, 10C, 10D of the coils 9A, 9B each are attached to areas of the lateral surface of the voice coil 2 opposing each other diametrically. The coils 9A, 9B are applied on the outside of the voice coil 2 reducing the airgap by ˜20 μm. Coil 9B is rotated with regard to coil 9A about an axis perpendicular to a surface of the membrane 3. Preferably coil 9B is rotated about 90° with regard to coil 9A as can be seen in FIG. 4.

Each coil 9A, 9B comprises a base portion 11A, 11B, wherein the lateral portions 10A, 10B, 10C, 10D are tilted with respect to the base portion 11A, 11B.

According to FIG. 5 coils 9A, 9B each may comprise two plates or film shaped parts 12A, 12B, 12C, 12D wherein a bonding layer 13A, 13B is arranged in between the first plate or film shaped part 12A, 12C and a second plate or film shaped part 12B, 12D.

Preferably the bonding layer 13A, 13B is made of an electrically insulating material.

The first plate or film shaped part 12A, 12C is electrically connected to the second plate or film shaped part 12B, 12D by means of the lateral portions 10A, 10B, 10C, 10D.

The first figure 8-shaped coil 9A and the second figure 8-shaped coil 9B may be bonded together by means of a bonding layer. Preferably this bonding layer is made of an electrically insulating material. Coils 9A and 9B can constitute a membrane plate 14A. Accordingly, this membrane-plate 14A consists of the two sandwiched Coils 9A and 9B, which are glued together.

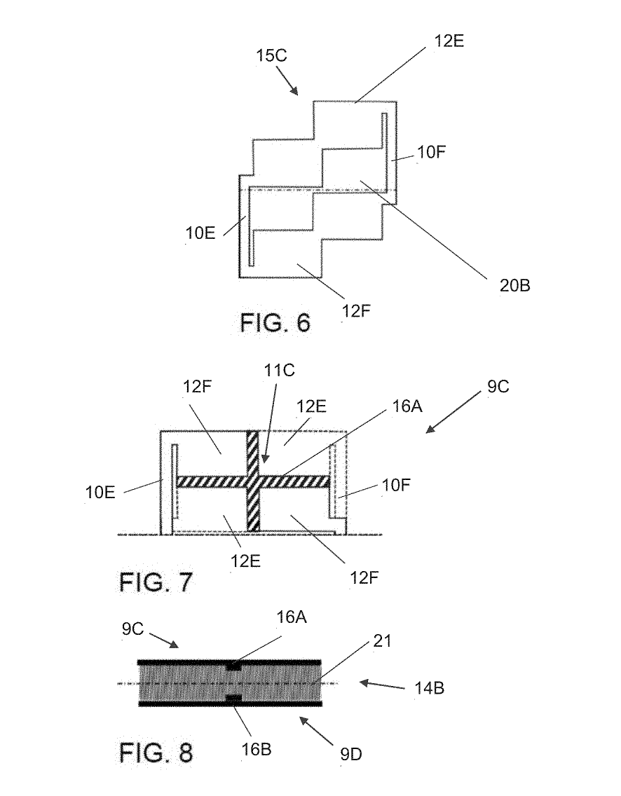

FIG. 8 shows a section through a membrane plate 14B comprising two figure 8-shaped coils 9C and 9D as shown in FIGS. 6-7 and a bonding layer 21.

The passive tumble damping of a membrane as described above achieves an electric damping of tumbling regardless of frequency, temperature, humidity and aging. The cross-sectional area of the figure-8 shaped coils 9A, 9B, 9C, 9D is directly related to the achievable damping force and can therefore be optimized to influence the acoustical performance (resonance, sensitivity) as little as possible.

Referring to FIGS. 1-10 a Method according to the invention shall be described in greater detail. The method for producing the loud speaker driver la comprises the steps:

Providing a film of electrically conductive material, in particular the film a metal-film, such as an aluminum-foil (e.g. a standard 10-20 μm aluminum foil);

Cutting or stamping of the film to achieve a loop shape structure 15A, 15B, 15C, 15D—holes may be cut in order to reduce mass. The holes can be configured asymmetrically or symmetrically with respect to the rectangular shape.

Folding of the loop shaped structure 15A, 15B, 15C, 15D;

Attaching at least the base part 11A, 11B, 11C of the folded loop shaped structure 15A, 15B, 15C, 15D to the membrane 3 of the loudspeaker driver 1a;

Attaching lateral areas 10A, 10B, 10C, 10D, 10E, 10F, 10G, 10H of the folded loop-shaped structure to lateral surfaces of the voice coil 2 of the loudspeaker driver 1a.

Adhesive may be applied to overlapping areas 16A, 16B of the base part 11A, 11B, 11C, 11D before folding of the loop shaped structure 15A, 15B, 15C, 15D.

Furthermore, the surface of the film may be treated to become electrically insulating before step iii). The (aluminum) foil can be pre-processed with hot steam to be non-conductive at the surface.

According to FIGS. 5, 6 and 9 the film may be cut or stamped in step ii) to have a shape comprising two main areas 12A, 12B, 12C, 12D, 12E, 12F, 12G, 12H being spaced apart from each other by means of a gap 20A, 20B, 20C; the first and the second main area being electrically and mechanically connected with one another by means of two strips forming the lateral portions 10A, 10B, 10C, 10D, 10E, 10F, 10G, 10H connecting corresponding edges of the main areas 12A, 12B, 12C, 12D, 12E, 12F, 12G, 12H.

After cutting the film a bonding layer (double adhesive or any other glue) may be applied on one side of the structure. Then the structure may be folded along a symmetry axis intersecting the two lateral portions 10A, 10B, 10C, 10D, 10E, 10F, 10G, 10H and bringing the respective corresponding areas 12A, 12B, 12C, 12D, 12E, 12F, 12G, 12H into alignment with one another.

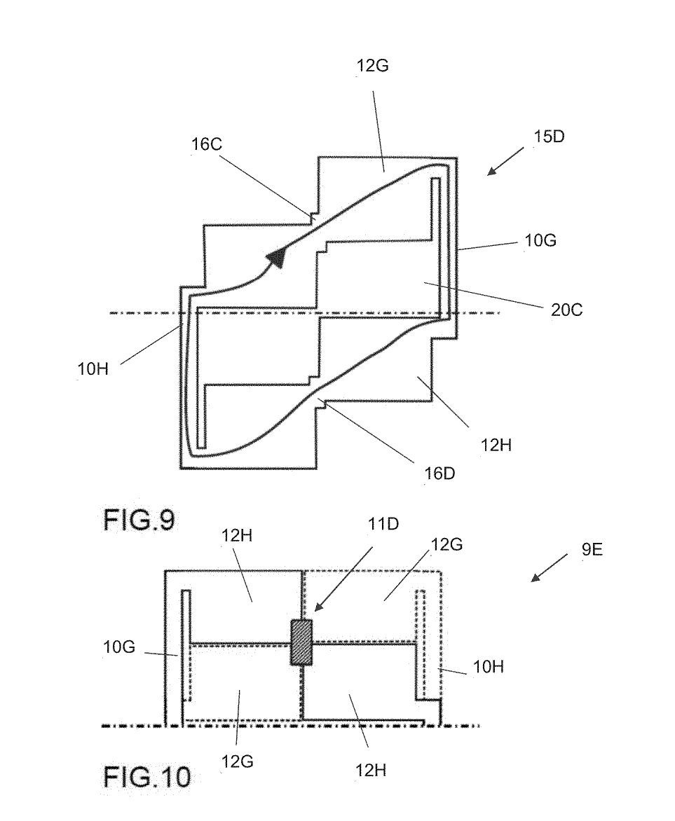

According to the embodiment shown in FIGS. 6-10 it is not necessary to glue the metal layers together to produce a figure 8-shaped coil. Since the metal layers 12E, 12F, 12G, 12H are acting as sandwich structure lying in two opposite quarters of the figure 8-shaped coils 9C, 9D. 9E. But, nevertheless to strengthen the structure mechanically overlapping areas 16A, 16B, 16C, 16D can be designed as shown in FIGS. 7 and 9. The impedance of the coil 9C, 9D, 9E is defined mainly by the lateral areas 10E, 10F, 10G, 10H contacting the voice coil 2, so the crossing area in the middle needs to be only in the range of that legs as shown in the picture. The current-flow in FIGS. 7 and 9 is indicated with arrows. The outline of the lower layer is indicated with a continuous line, whereas the outline of the upper layer is indicated with a dashed line.

After producing a first and a second folded loop shaped structures 15A, 15B, 15C, 15D constituting figure 8-shaped coils the first and second folded loop-shaped structure 15A, 15B, 15C, 15D can be bonded together in a manner that a symmetry axis of the second folded loop-shaped structure traverses a symmetry axis of the first folded loop-shaped structure. The folded loop-shaped structures constitute the figure 8-shaped coils. FIG. 8 shows a cross-section of a sandwich structure consisting of two figure 8-shaped coils 9C, 9D and a boning layer 13 in between.

Furthermore, a base portion of the first or the second loop-shaped structure 15A, 15B, 15C, 15D may be attached to the membrane 3 and the lateral areas 10A, . . . , 10H to lateral surfaces of the voice coil 2. Preferably, the symmetry axis of the first folded loop-shaped structure 15A, 15C is essentially perpendicular to the symmetry axis of the second folded loop-shaped structure 15B, 15D.

FIGS. 9 and 10 show an optimized version of the coil 9C of FIGS. 7 and 8. The current path is drawn explicitly in FIG. 9. As can be seen one only has to make sure that the crossing in the center area does show sufficient metal in order to keep the resistance low.

The folded structure of FIG. 10 reveals the significant reduction of the overlapping area in the middle. Optimal shape of the middle area is a square tilted by 45° with the side length equal to the leg-height.

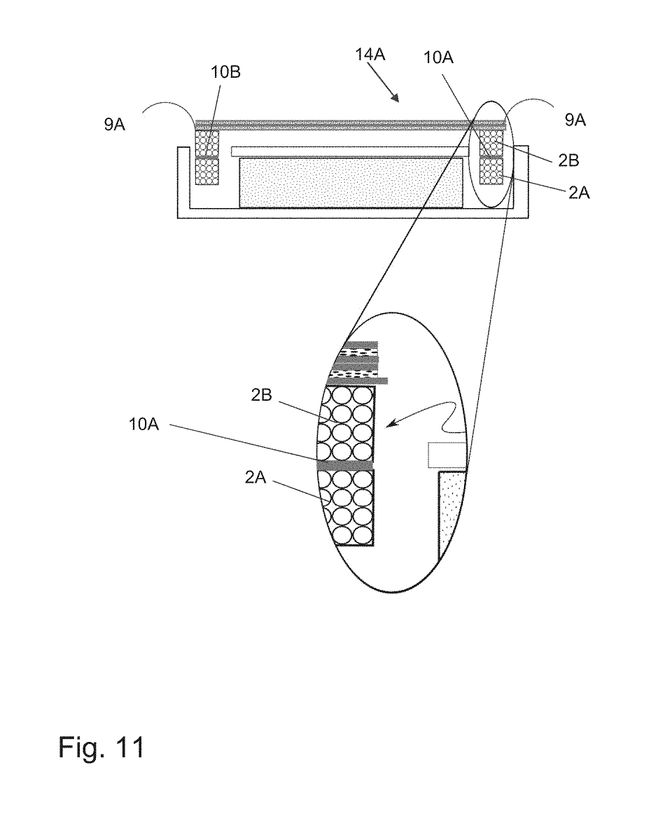

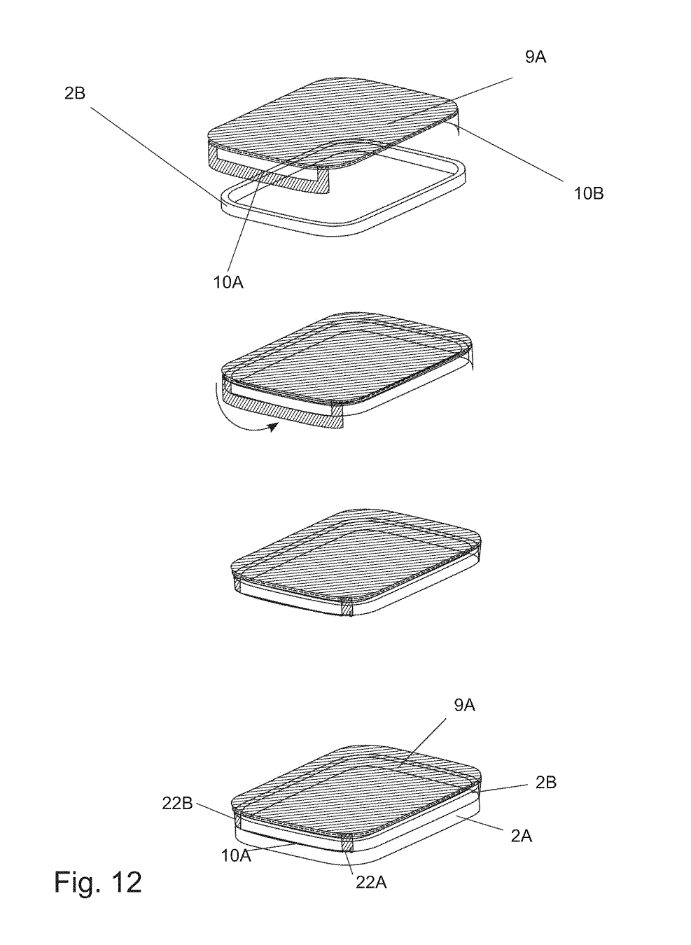

According to FIG. 11 the voice coil can be made of two coils 2A and 2B being arranged coaxially to each other. The lateral portions 10A, 10B of the figure 8-shaped coil 9A can be attached to the front end of the coil 2B facing coil 2A and to the corresponding front end of the coil 2A. Parts of the lateral portions 10A, 10B of the figure 8-shaped coil 9A are arranged in between the at least two coils. Stays 22A, 22B of the lateral portions 10A, 10B of figure 8-shaped coil 9A are arranged on the lateral surface of coil 2B as can be seen FIG. 12.

As can be also seen in FIG. 12 lateral parts 10A, 10B of the figure 8-shaped coil 9A are bent over a front edge of coil 2B. The lateral portions 10A, 10B may be adhered to the front end of coil 2B. In a next step the second coil 2A can be attached to coil 2B so that parts 10A, 10B of the figure 8-shaped come to lie in between the coils 2A, 2B.

Of course a second figure 8-shaped coil as described above and shown in FIGS. 4-10 can be used in addition to coil 9A.

The invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

What is claimed is:

1. A dynamic loudspeaker driver, comprising a magnet-system;
a membrane; the membrane being movably mounted with respect to the magnet-system;
at least one voice coil attached to the membrane and operatively coupled with the magnet-system;
at least one figure 8-shaped coil attached to the membrane and to the at least one voice coil, wherein parts of the figure 8-shaped coil cover at least partially a lateral surface of the at least one voice coil.

2. The loudspeaker driver of claim 1, wherein the at least one figure 8-shaped coil is arranged between the membrane and the voice coil.

3. The loudspeaker driver of claim 1, wherein lateral portions of the at least one figure 8-shaped coil are attached to at least two areas of the lateral surface of the voice coil opposing each other diametrically.

4. The loudspeaker driver of claim 3, wherein the at least one figure 8-shaped coil comprises a base portion attached to the membrane and the lateral portions attached to the voice coil, wherein the lateral portions of the figure 8-shaped coil are tilted with respect to the base portion of the figure 8-shaped coil.

5. The loudspeaker driver of claim 4, wherein the base portion of the at least one figure 8-shaped coil comprises at least two plate or film shaped parts, wherein a bonding layer is arranged in between a first plate or film shaped part of the two plate or film shaped parts and a second plate or film shaped part of the two plate or film shaped parts.

6. The loudspeaker driver of claim 5, wherein the bonding layer is made of an electrically insulating material.

7. The loudspeaker driver of claim 5, wherein the first plate or film shaped part is electrically connected to the second plate or film shaped part by means of the lateral portions.

8. The loudspeaker driver of claim 1 comprising at least two figure 8-shaped coils attached to the membrane and the voice coil and at least partially covering lateral surface areas of the at least one voice coil, wherein a second figure 8-shaped coil of the at least two figure 8-shaped coils is rotated with regard to a first figure 8-shaped coil of the at least two figure 8-shaped coils.

9. The loudspeaker driver of claim 8, wherein the second figure 8-shaped coil is rotated about 90° with regard to the first figure 8-shaped coil.

10. The loudspeaker driver of claim 8, wherein the first figure 8-shaped coil and the second figure 8-shaped coil are bonded together by means of a bonding layer.

11. The loudspeaker driver of claim 10, wherein the bonding layer is made of an electrically insulating material.

12. The loudspeaker driver of claim 4, wherein the at least one voice coil comprises at least two coils arranged coaxially to each other, wherein the lateral portions of the at least one figure 8-shaped coil are at least partially arranged in between the at least two coils.

13. Method of producing a dynamic loudspeaker driver according to claim 1 comprising the steps of:
providing a film of electrically conductive material;
cutting or stamping of the film to achieve a loop shape structure;
folding of the loop shaped structure,
attaching at least a base part of the folded loop shaped structure to a membrane of the loudspeaker driver; and
attaching lateral areas of the folded loop-shaped structure to the voice coil and at least partially covering lateral surfaces of a voice coil of the loudspeaker driver with the lateral areas of the folded loop-shaped structure.

14. The method of claim 13, wherein adhesive is applied to the overlapping areas of the base part before folding of the loop shaped structure.

15. The method of claim 13, wherein the surface of the film is treated to become electrically insulating before step iii).

16. The method of claim 13, wherein the film is cut in step ii) into a shape having two main areas lying side by side and being spaced apart from each other by means of a gap; the first and the second main area being electrically and mechanically connected with one another by means of two strips connecting corresponding edges of the two main areas.

17. The method of claim 16 comprising the step of folding the film along a symmetry axis intersecting the two strips, and bringing the first main area into alignment with the second main area.

18. The method of claim 13, comprising the steps of producing a first and a second folded loop-shaped structure; bonding together of the first and second folded loop-shaped structure, wherein a symmetry axis of the second folded loop-shaped structure traverses a symmetry axis of the first folded loop-shaped structure; attaching a base portion of the first or the second loop-shaped structure to the membrane and lateral areas of the first and the second loop-shaped structures to lateral surfaces of the voice coil.

19. The method of claim 18, wherein the symmetry axis of the first folded loop-shaped structure is essentially perpendicular to the symmetry axis of the second folded loop-shaped structure.

20. The method of claim 18, wherein the film used in step i) is a metal-film.

21. The method of claim 20, wherein the metal-film is an aluminum film.

22. The method of claim 13, wherein at least two coils are used to produce the at least one voice coil and wherein lateral areas of the at least one figure 8-shaped coil are arranged in between the at least two coils.

23. A membrane plate for the membrane of the loudspeaker driver according to claim 1, wherein the membrane plate comprises at least one figure 8-shaped coil.
